(19) United States
(12) Patent Application Publication
(10) Pub. No.: US 2007/0220080 A1
(43) Pub. Date: Sep. 20, 2007

(54) Method, system, and computer program product for downloading medical awareness objects on communication devices

(76) Inventor: Sean Humphrey, Morgan Hill, CA (US)

Correspondence Address: Sean Humphrey, P.O. Box 3165, Santa Clara, CA, 95055, US

(21) Appl. No.: 11/365,541

(22) Filed: Mar. 1, 2006

(51) Int. Cl. G06F 15/16

(52) U.S. Cl. 709/203

(57) ABSTRACT

Disclosed is a method, system, and computer program product for downloading medical awareness objects on communication devices. In one embodiment, the method comprises: accessing a web server through a network by the communication device; sending a menu data to be displayed on the communication device upon authentication of the communication device by the web server; sending a download request on selecting the medical awareness object from the menu data by the communication device; accessing a database having the medical awareness object by the web server, on receiving the download request; and transmitting the medical awareness object from the web server to the communication device, thereby downloading the medical awareness object on the communication device.

### FIELD OF THE INVENTION

The present invention relates to a method, system, and computer program product for downloading medical awareness objects, representing medical disorders, on communication devices.

### BACKGROUND OF THE INVENTION

Promoting medical awareness is a significant issue within the health sector. By promoting awareness on medical disorders, there is a possibility that people will not only maintain and promote their health, but also that of their environment. Housing conditions, environment, social support and care also have a significant impact on promoting awareness on medical disorders. The promotion of health and welfare is not a task exclusively of health care professionals. Rather the responsibility is shared by a wide group of operators and decision-makers in various sectors of society. Health is an important asset for the society, a resource for both the individual and the community and part of overall well-being of a nation at large.

The conventional means such as newspapers, pamphlets, television, radio, and the like, have played a role in spreading the awareness on medical disorders in the society to a great extent. However, with the advent of information technology, the focus of medical awareness is shifting from conventional means to internet, cellular phones and data retrieval systems. Information technology has also changed the way people can access knowledge and the way they communicate with one another in daily behavior. The number of people using these mediums of communication to retrieve health information in increasing day by day. Various communication medium including mobile communication devices such as, cellular phones, handheld devices and the like; radios, television and the internet has enlarged as a significant tool within the health sector, as well as for health promotion in the society.

Accordingly, what is needed is a way for downloading medical awareness objects, representing medical disorders directly on mobile communication devices that can inspire people to fight against a medical disorder.

### SUMMARY OF THE INVENTION

The general purpose of the present invention is to provide a method, system, and computer program product for downloading animated medical awareness objects, to include all the advantages of the prior art, and to overcome the drawbacks inherent therein.

In one aspect, the present invention provides a method for downloading a medical awareness object on a communication device, comprising: accessing a web server through a network by the communication device; sending a menu data to be displayed on the communication device upon authentication of the communication device by the web server; sending a download request on selecting the animated medical awareness object from the menu data by the communication device; accessing a database having the medical awareness object by the web server, on receiving the download request; and transmitting the medical awareness object from the web server to the communication device, thereby downloading the medical awareness object on the communication device.

In another aspect, the present invention comprises a system having at least one mobile communication device; a network; a web server; and a database having at least one animated medical awareness object. The system implements a method for downloading the animated medical awareness object on the mobile communication device, the method comprising: accessing the web server through the network by the mobile communication device; sending a menu data to be displayed on the mobile communication device upon authentication of the communication device by the web server; sending a download request on selecting the animated medical awareness object from the menu data by the mobile communication device; accessing the database by the web server, on receiving the download request; and transmitting the animated medical awareness object from the web server to the mobile communication device, thereby downloading the animated medical awareness object on the mobile communication device.

In another aspect, the present invention provides a computer program product comprising a computer readable medium having computer executable instructions recorded thereon for downloading an animated medical awareness object on a communication device, the computer program product performing a method, comprising the steps of: accessing a web server through a network by the communication device; sending a menu data to be displayed on the communication device upon authentication of the communication device by the web server; sending a download request on selecting the animated medical awareness object from the menu data by the communication device; accessing a database having the animated medical awareness object by the web server, on receiving the download request; and transmitting the animated medical awareness object from the web server to the communication device, thereby downloading the animated medical awareness object on the communication device.

These together with other aspects of the present invention, along with the various features of novelty that characterize the invention, are pointed out with particularity in the claims annexed hereto and forming a part of this disclosure. For a better understanding of the invention, its operating advantages, and the specific objects attained by its uses, reference should be made to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, wherein:

FIG. 1 is a block diagram illustrating a system 100 for downloading animated medical awareness objects on a mobile communication device 10, according to an exemplary embodiment of the present invention;

FIG. 2 is a block diagram of the mobile communication device 10, according to an exemplary embodiment of the present invention;

FIG. 3 is a flowchart of a method for downloading animated medical awareness objects, according to an exemplary embodiment of the present invention;

FIG. 4 is a perspective view of a 3D animation ribbon, an exemplary animated medical awareness object; and

FIGS. 5A-5J represent different stages during play back of the 3D animation awareness ribbon of FIG. 4, on the mobile communication device 10.

Like reference numerals refer to like parts throughout several views of the drawings of the present invention.

### DETAILED DESCRIPTION OF THE INVENTION

For a thorough understanding of the subject invention, reference is to be made to the following detailed description, including the appended claims, in connection with the above-referenced drawings. Although, the present invention is described in connection with several embodiments, the invention is not intended to be limited to the specific forms set forth herein. On the contrary, it is intended to cover such alternatives, modifications, and equivalents as can be reasonably included within the scope of the invention as defined by the appended claims.

In the following description, for purposes of explanation, numerous specific details are set forth in order to provide a thorough understanding of the invention. It will be apparent, however, to one skilled in the art that the invention can be practiced without these specific details.

The present invention provides a method, system, and computer program product for downloading medical awareness objects on communication devices. An end user by downloading such an animated medical awareness object, may draw attention to those personally affected with corresponding medical disorders, thereby inspiring awareness and a call to action for funding the fight against medical disorders and further finding a cure for such medical disorders.

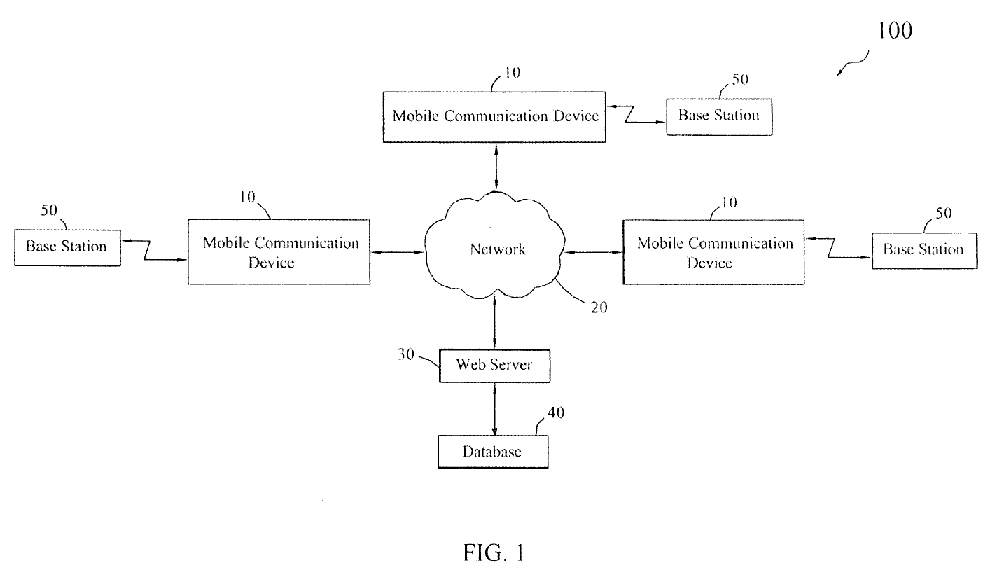

Referring to FIG. 1, there is provided a system 100 for downloading medical awareness objects. The system 100 comprises at least one mobile communication device 10, network 20, a web server 30, and a database 40 having at least one animated medical awareness object. As used herein, the animated medical awareness object refers to data files stored in the database 40. In one embodiment, the medical awareness object is an animated medical awareness object representing a medical disorder.

The mobile communication device 10 establishes a connection to the web server 30. The web server 30 access the database 40 via a cellular service provider. The mobile communication device 10 may be a cellular phone, a personal digital assistant (PDA), a wireless phone, a handheld device, or the like.

The system 100 further comprises a base station 50. The base station 50 transmits and receives signals from and to the mobile communication device 10. The mobile communication device 10 may access the web server 30 for downloading animated medical awareness object through the base station 50 and the network 20. The transmitting power of the base station 50 may be variable and depend on several factors, including the number of requests for downloading animated medical awareness objects, and the distance between the base station 50 and the mobile communication device 10 making such download requests.

The network 20 defines a channel for connecting the download request originating from the mobile communication device 10 to the web server 30. The web server 30 is connected to the network 20. The web server 30 comprises web page contents to be delivered to the mobile communication device 10 using one or more communication protocols, for example, hypertext transfer protocol (HTTP), and the like.

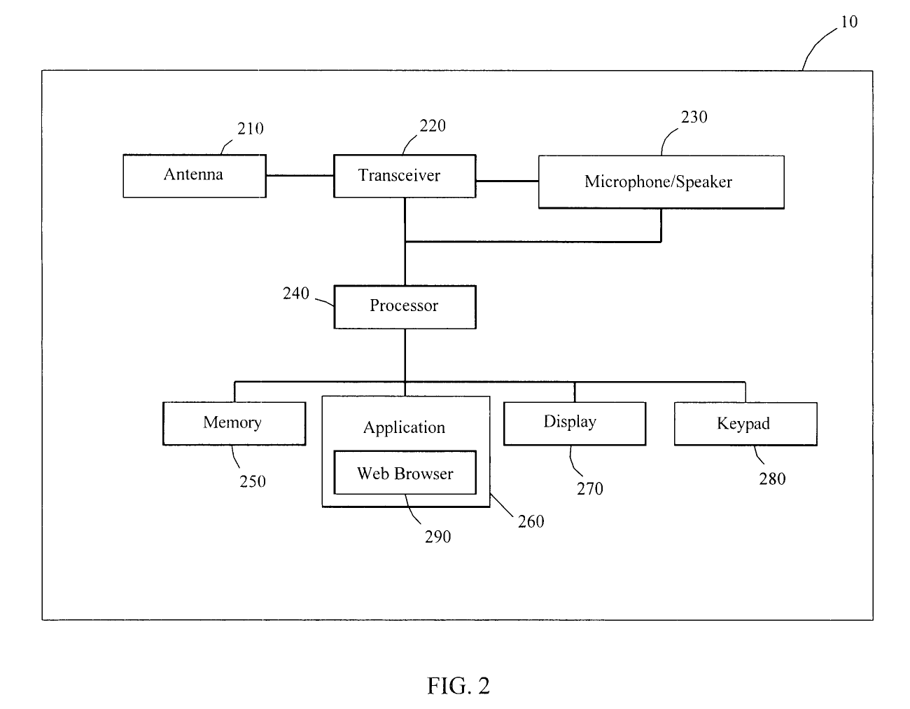

Now, referring to FIG. 2, a mobile communication device 10 for downloading the animated medical awareness objects, is shown. The mobile communication device 10 comprises an antenna 210, transceiver 220, microphone/speaker 230, processor 240, memory 250, and an application 260. The application 260 comprises a web browser 290 for retrieving the contents of the web pages from the web server 30. The web browser 290 includes web-browser frame for displaying a portion of the retrieved web page. The downloaded animated medical awareness object may be stored locally in the memory 250 of the mobile communication device 10. The web browser 290 executes and plays the animated medical awareness object. The mobile communication device 10 further comprises a display 270 for displaying play back of the animated medical awareness object, and a keypad 280 for the input of the predetermined Universal Resource Locator (URL) for accessing the contents of the web page in the web server 30.

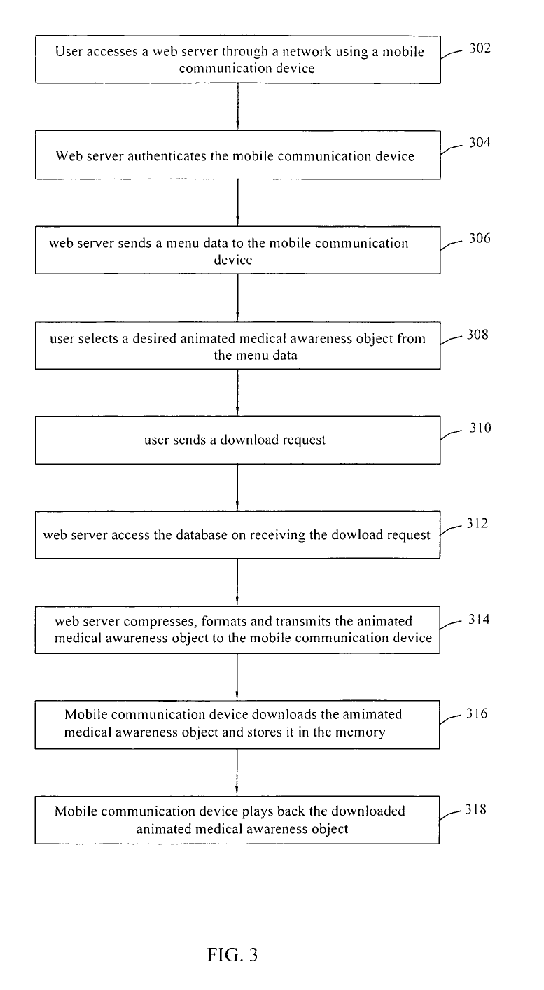

Now referring to FIG. 3, a logical process of a method for downloading animated medical awareness objects representing medical disorders, is illustrated. A user inputs a predetermined URL in the web browser 290 of the mobile communication device 10 and accesses the contents in the web page of the web server 30 through the network 20, at step 302. The web server 30 authenticates the mobile communication device 10, at step 304, and sends a menu data to the web browser 290 of the mobile communication device 10, at step 306. The user then browses the menu data viewed on display 270 of the mobile communication device 10 and selects a desired animated medical awareness object from the menu data, at step 308; and subsequently sends a download request, at step 310. On receiving the download request, the web server 30 accesses the database 40 containing the animated medical awareness object, at step 312. The web server 30 compresses and formats the 3D animation file in a file format including, but not limited to, Moving Picture Experts Group (MPEG), MPEG-1, MPEG-2, MPEG 4, Third Generation Phone (3GP) video file format, and transmits the compressed animated medical awareness objects across the user, at step 314. Preferably, the animated medical awareness objects, when compressed and formatted for low bandwidth web interface links (for example 9600 bits per second), is uploaded to the database 40, on the web server 30. The application 260 residing in the mobile communication device 10 of the user downloads the animated medical awareness objects and stores it in the memory 260, at step 316. Once the animated medical awareness objects is stored in the memory 260, the mobile communication device 10 plays the animated medical awareness objects representing medical disorders, at step 318. The downloaded medical awareness objects may also be personalized according to the user needs, for example, text description may also be added to the animated medical awareness objects along with music in the form of a ring tone for the mobile communication device 10.

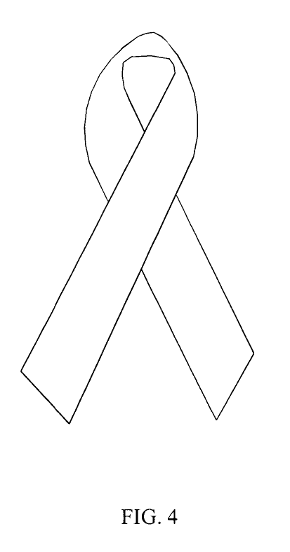

Referring to FIG. 4, in one embodiment, the animated medical awareness object is a three dimensional (3D) animation ribbon representing a particular medical disorder, is shown. The 3D animation ribbon comprises a particular color or a combination of colors, representing a particular medical disorder. Some of the animated ribbons of different colors representing corresponding medical disorders, include: white for bone disease; green for donor bone marrow; gray for brain cancer; burgundy for brain aneurysm; silver for brain disability, brain tumors and brain disorders; pink for breast cancer; pink/blue for breast cancer (male); purple for ADD and ADHD; white for adoptee; burgundy/silver outline for adults with physical disabilities; red for AIDS; gray for allergies; blue for alopecia; pinstripe for ALS; purple for Alzheimer's; yellow for amber alert; purple for animal abuse; brown for anti-tobacco; gray for aphasia; red/white for aplastic anemia; blue for ARDS; purple for Arnold chiari malformation; blue for arthritis; gray for asthma; puzzle for autism; light blue for beheets disease; green for bipolar; pink for birth parents; yellow for bladder cancer; white for bone cancer.

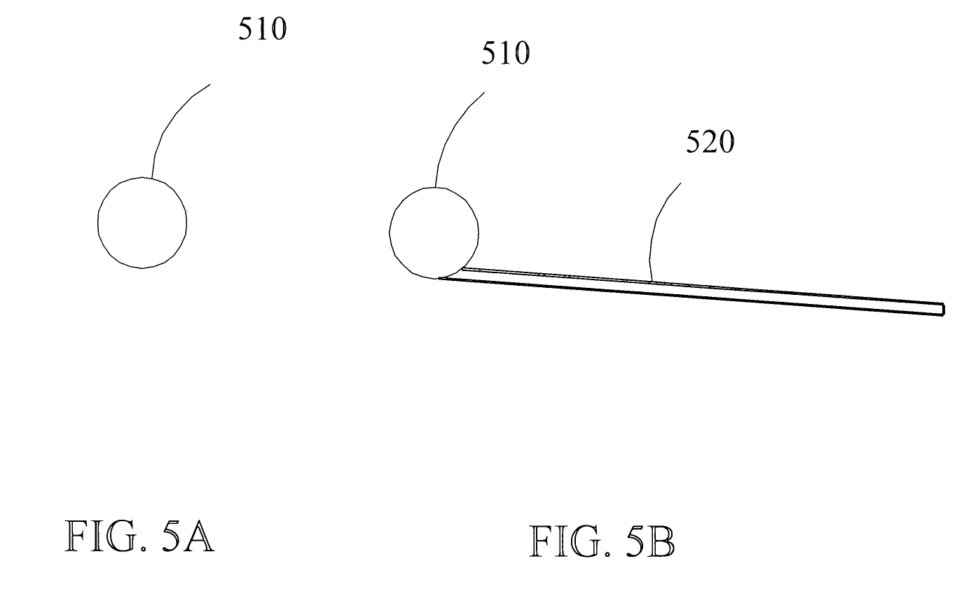

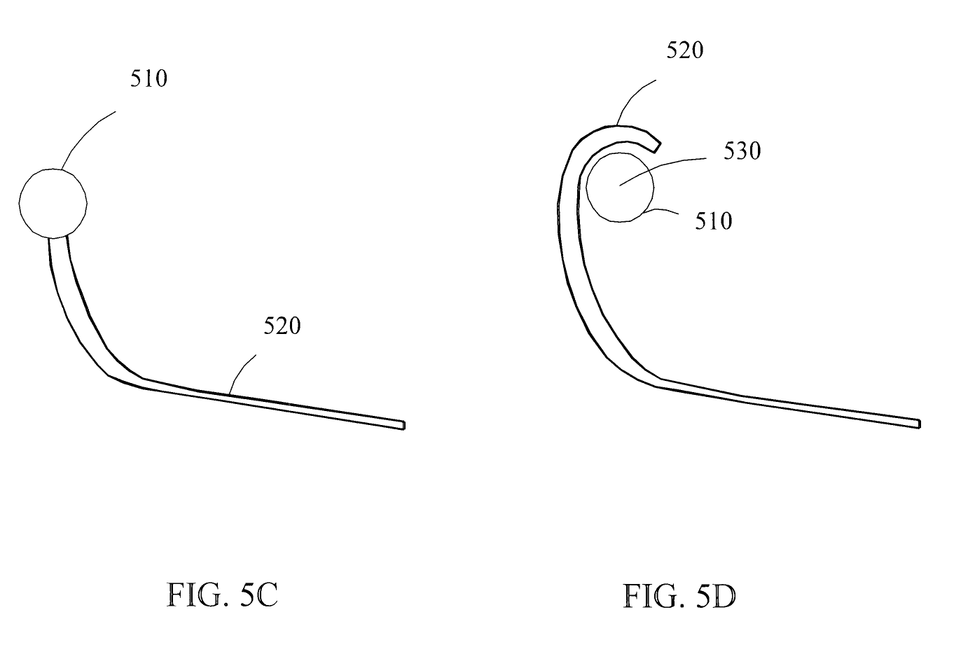

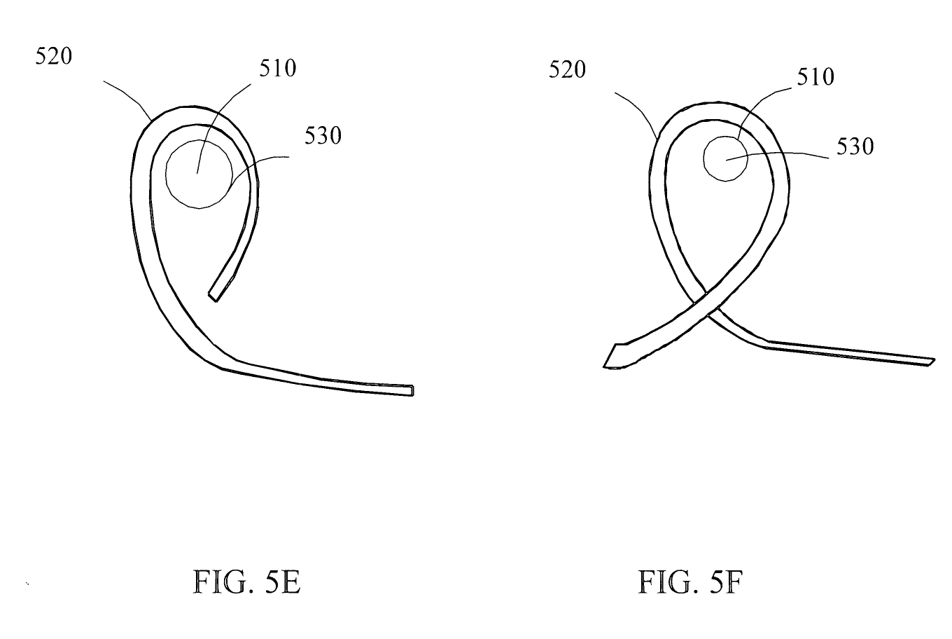

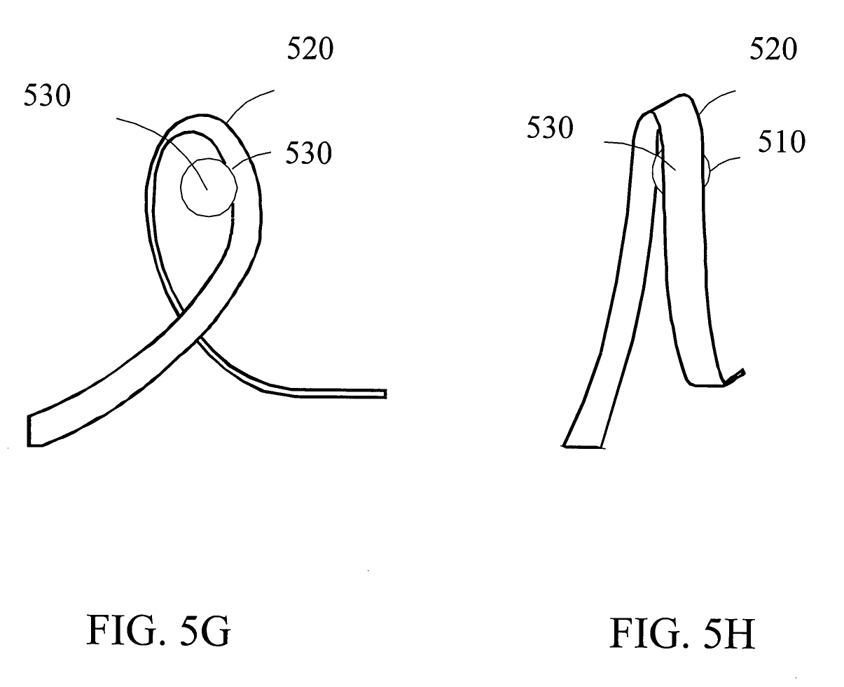

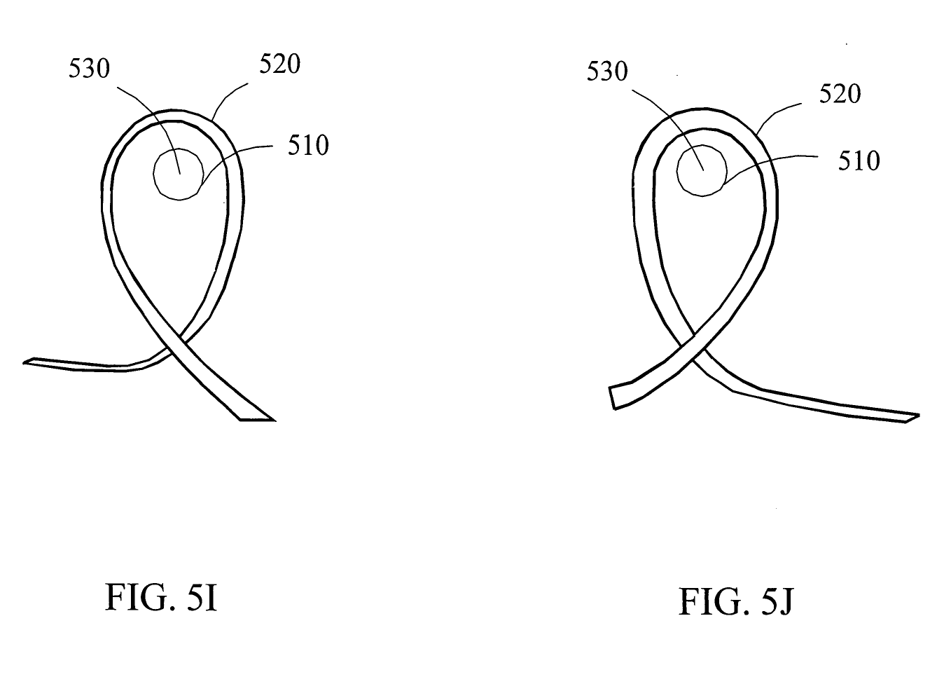

Next, referring to FIGS. 5A-5J, the different stages from beginning to end during play back (of approximately 11 seconds) of the 3D animation ribbon on the mobile communication device 10 is shown. The play back begins showing a globe 510 (a spherical object equivalent to replica of the world), as shown in FIG. 5A. Next, an arm 520, as shown in FIG. 5B, stretches from a bottom portion of the globe 510 to create a path. The globe 510 travels in the path created by the arm 520, as shown in FIG. 5C, and finally the globe 510 stops at a predetermined point 530, as shown in FIG. 5D. The globe 510 keeps on rotating at that predetermined point 530. The arm 520 continues stretching in a direction as shown in FIG. 5E and crosses itself to form a loop around the globe 510, as shown in FIG. 5F. After the loop is formed, both the globe 510 and arm 520 rotate until the play back stops, illustrating different views of the globe 510 and the arm 520, as shown in FIGS. 5G-5J. In one embodiment, the animation ribbon is played at the rate of 30 frames per second.

Various embodiments may further include receiving, sending or storing instructions and or/data that implement the functionality of downloading animated medical awareness object on communication devices, in accordance with the present invention, upon a computer readable medium. Such a computer readable medium may include but is not limited to a storage media or memory media such as magnetic media (e.g., floppy disks), or optical media (e.g., disk or CD-ROM), volatile or non volatile media such as Random Access Memory (RAM), Read Only Memory (ROM), and the like, as well as transmission media or signals such as electrical, electromagnetic, or digital signals, conveyed via a communication means such as wired network and/or wireless link, wherein, when a computer program code, implementing the embodiments of the present invention, is loaded onto and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A method for downloading a medical awareness object on a communication device, comprising:
accessing a web server through a network by the communication device;
sending a menu data to be displayed on the communication device upon authentication of the communication device by the web server;
sending a download request on selecting the medical awareness object from the menu data by the communication device;
accessing a database having the medical awareness object by the web server, on receiving the download request; and
transmitting the medical awareness object from the web server to the communication device, thereby downloading the animated medical awareness object on the communication device.

2. The method of claim 1, wherein the communication device is a mobile communication device selected from the group consisting of cellular phones, wireless phones, personal digital assistants, and handheld devices.

3. The method of claim 1, wherein the method further comprises playing the animated medical awareness object on the communication device.

4. The method of claim 1, wherein the method further comprises compressing and formatting the medical awareness object before transmitting the medical awareness object from the web server to the communication device.

5. The method of claim 4, wherein the medical awareness object is compressed and formatted using a MPEG file format or a 3GP file format.

6. The method of claim 1, wherein the medical awareness object is personalized by adding text description.

7. The method of claim 1, wherein the medical awareness object is personalized by adding music in the form of a ring-tone for the communication device.

8. The method of claim 1, wherein the medical awareness object is a three-dimensional animation ribbon.

9. The method of claim 1, wherein the downloaded medical awareness object is locally stored in a memory of the communication device.

10. A system, comprising:
at least one mobile communication device;
a network;
a web server; and
a database having at least one animated medical awareness object;
wherein the system implements a method for downloading the animated medical awareness object on the mobile communication device, the method comprising:
accessing the web server through the network by the mobile communication device;
sending a menu data to be displayed on the mobile communication device upon authentication of the communication device by the web server;
sending a download request on selecting the animated medical awareness object from the menu data by the mobile communication device;
accessing the database by the web server, on receiving the download request; and
transmitting the animated medical awareness object from the web server to the mobile communication device, thereby downloading the animated medical awareness object on the mobile communication device.

11. The system of claim 10, wherein the mobile communication device is selected from the group consisting of cellular phones, wireless phones, personal digital assistants, and handheld devices.

12. The system of claim 10, wherein the animated medical awareness object is compressed and formatted using a MPEG file format or a 3GP file format.

13. The system of claim 10, wherein the animated medical awareness object is personalized by adding text description.

14. The system of claim 10, wherein the animated medical awareness object is personalized by adding music in the form of a ring-tone for the communication device.

15. The system of claim 10, wherein the animated medical awareness object is a three-dimensional animation ribbon.

16. The system of claim 10, wherein the downloaded animated medical awareness object is locally stored in a memory of the mobile communication device.

17. A computer program product having a computer readable medium having computer executable instructions recorded thereon for downloading a animated medical awareness object on a communication device, the computer program product performing a method, comprising:
accessing a web server through a network by the communication device;
sending a menu data to be displayed on the communication device upon authentication of the communication device by the web server;
sending a download request on selecting the animated medical awareness object from the menu data by the communication device;
accessing a database having the animated medical awareness object by the web server, on receiving the download request; and
transmitting the animated medical awareness object from the web server to the communication device, thereby downloading the animated medical awareness object on the communication device

18. The computer program product of claim 17, wherein the communication device is a mobile communication device selected from the group consisting of cellular phones, wireless phones, personal digital assistants, and handheld devices.

19. The computer program product of claim 17, wherein the animated medical awareness object is compressed and formatted using a MPEG file format or a 3GP file format.

20. The computer program product of claim 17, wherein the downloaded animated medical awareness object is a three-dimensional animation ribbon.
